(19) United States
(12) Patent Application Publication
(10) Pub. No.: US 2004/0245926 A1
(43) Pub. Date: Dec. 9, 2004

(54) Plasma color display screen with color filters

(76) Inventors: Hans-Helmut Bechtel, Roetgen (DE); Markus Heinrich Klein, Aachen (DE); Joachim Opitz, Aachen (DE)

Correspondence Address: Eric Bram, US Philips Corporation, Intellectual Property Department, P O Box 3001, Briarcliff Manor, NY, 10510, US

(21) Appl. No.: 10/478,735

(22) PCT Filed: May 24, 2002
(86) PCT No.: PCT/IB02/01844

(30) Foreign Application Priority Data
May 28, 2001 (DE) 101 26 008.3

(51) Int. Cl. H01J 17/49

(52) U.S. Cl. 313/582; 313/586; 313/112

(57) ABSTRACT

A plasma color display screen comprising a carrier plate, a transparent front plate, separating ribs which divide the space between the carrier plate and the front plate into discharge cells which are filled with a gas, one or more electrode arrays on the front plate and on the carrier plate to generate corona discharges in the discharge cells, a structured phosphor layer on the front plate composed of segments with red, green and blue-emitting phosphors and a structured filter layer of segments with color filters selected from the group of red, green and blue color filters, which filter layer is arranged between the inner surface of the front plate and the structured phosphor layer.

The invention relates to a plasma color display screen comprising a carrier plate, a transparent front plate, separating ribs which divide the space between the carrier plate and the front plate into discharge cells that are filled with a gas, one or more electrode arrays on the front plate and on the carrier plate to generate corona discharges in the discharge cells, and comprising a phosphor layer and a filter layer.

The principle on which a plasma display screen is based is that crossed electrode arrays between a carrier plate and a transparent front plate form a matrix, and between the intersecting individual electrodes of said matrix the voltage can be controlled in such a manner that gas discharge takes place at the points of intersection. The resultant phosphorescent gas plasma is visible as a luminous spot through the transparent front plate.

In the color version of the plasma display screen, the display screen comprises a structured phosphor layer with segments to generate the colors red, green and blue. A pixel, i.e. a picture element, comprises three sub-pixels for the three primary colors on each segment of the phosphor layer. Customarily, the phosphor layer segments for the three sub-pixels are arranged next to each other in elongated phosphor strips. The individual phosphor strips are bounded by a ribbed structure of elongated separating ribs. These separating ribs serve to preclude crosstalk of the gas discharges from one discharge cell to other discharge cells.

Two versions of plasma color display screens are known. In reflection-type plasma color display screens, the phosphor strips are arranged on the carrier plate in the colors red, green and blue and are excited so as to emit light by the gas plasma ignited in front of them. In transmission-type plasma color display screens, the phosphor strips are arranged in the colors red, green and blue on the transparent front plate and are excited so as to emit light by a backward gas discharge.

Display screens and monitors of any design are frequently used in bright ambient light. In order to improve the visibility of the picture on the screen at ambient light conditions and reduce visual fatigue, a display screen should be characterized by absence of glare, a low reflectivity and a high contrast.

The contrast can be maximized by reducing the ambient light influence in relation to the intrinsic light density of the phosphors in the display screen coating. This can be achieved, for example, through transmissive color filters in the form of inorganic pigments, which are selected such that they exhibit maximum transparency to the color emitted by the phosphor in question and absorb the other spectral components, so that diffuse reflection of ambient light at the phosphor powder is suppressed. The manufacture of such filter arrangements comprising three transmissive filters for the phosphors in the three primary colors red, green and blue is complicated, however, for reflection-type plasma color display screens because the structured phosphor layer must be arranged on the carrier plate and the structured filter layer must be arranged on the front plate, and mutual aligning of the structured filter layer and the phosphor layer, which are situated on separate substrates, is very time-consuming.

U.S. Pat. No. 5,838,105 discloses a plasma color display screen comprising a front plate and a carrier plate, which are separated from each other by a discharge space, with the inner surface of the carrier plate being coated with phosphors layers in the colors red, green and blue, and the phosphor layers being capable of being excited to emit light by a gas discharge, and the outer surface of the front plate being coated with a green light-absorbing filter, and the inner surface of the front plate being coated with a monochromatic light-transmitting filter that is adapted to the red and blue phosphor layers and situated opposite said phosphor layers.

However, also this arrangement of transmissive filters and phosphor points on separate substrates requires mutual aligning of the phosphor layers on the carrier plate and the filter layers on the front plate in the colors red and blue.

It is an object of the invention to provide a plasma color display screen that supplies a high-contrast image, has a small reflection factor for external light, a high emission brightness and that can be manufactured in a cost-effective manner.

In accordance with the invention, this object is achieved by a plasma color display screen comprising a carrier plate, a transparent front plate, separating ribs which divide the space between the carrier plate and the front plate into discharge cells that are filled with a gas, one or more electrode arrays on the front plate and on the carrier plate to generate corona discharges in the discharge cells, a structured phosphor layer on the front plate composed of segments with red, green and blue-emitting phosphors and a structured filter layer composed of segments with color filters selected from the group of red, green and blue color filters, which filter layer is arranged between the inner surface of the front plate and the structured phosphor layer.

In this transmission-type plasma color display screen, the filter layer and the phosphor layer on the front plate are not spatially separated by the discharge space, but instead are arranged one above the other on the same substrate. By virtue thereof, the segments of the structured phosphor layer can be very readily co-ordinated with the segments of the structured filter layer.

This arrangement enables a suitable segment of the color filter layer to be assigned to individual segments or all segments of the phosphor layer. As a result, the colors appear brighter and more lucid. Disturbing reflexes are suppressed, for example the red filter segment above the red phosphor segment allows red light to pass, but absorbs other color components from the ambient light, which would otherwise be reflected as a disturbing, diffuse glare.

In accordance with an embodiment, the electrode array is arranged on the front plate between the filter layer and the front plate. In this embodiment, the filter layer acts as a protective layer for the electrode array.

In accordance with another embodiment of the invention, the electrode array may be arranged on the front plate between the filter layer and the phosphor layer.

In accordance with yet another embodiment of the invention, the segments of the color filter layer may be separated from each other by black segments. These black segments (“Black Matrix”) also improve the contrast.

Particularly advantageous effects in relation to the prior art are obtained by means of the invention if the separating ribs are arranged on the filter layer.

To improve the intrinsic absorption of emitted light in the phosphor layer, the walls of the separating ribs may additionally be coated with a phosphor layer, the thickness of which is larger than the layer thickness of the phosphor layer on the front plate. The intrinsic absorption is also reduced if the thickness of the phosphor layer on the separating ribs increases in the direction of the carrier plate.

In accordance with an embodiment of the invention, the electrode array on the carrier plate is covered, on the surface facing away from the carrier substrate, with a layer of a dielectric, visible light-reflecting material.

It may also be preferred that the electrode array on the carrier plate is coated, on the surface facing away from the carrier substrate or on the surface facing the carrier substrate, with a layer of a visible light-reflecting material.

These and other aspects of the invention are apparent from and will be elucidated with reference to the embodiment(s) described hereinafter.

In the drawings:

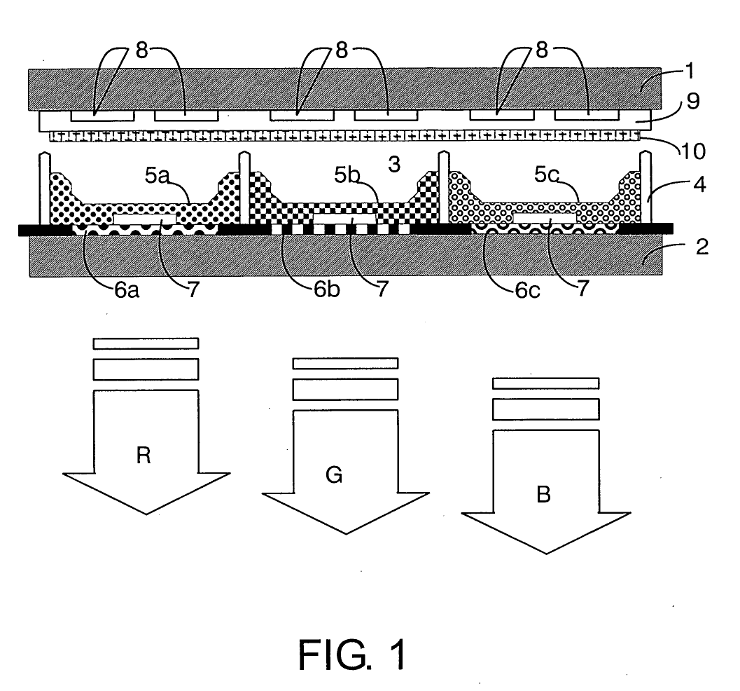

FIG. 1 is a diagrammatic, cross-sectional view of the structure of an example of a transmission plasma display screen of the surface-discharge type in accordance with the invention.

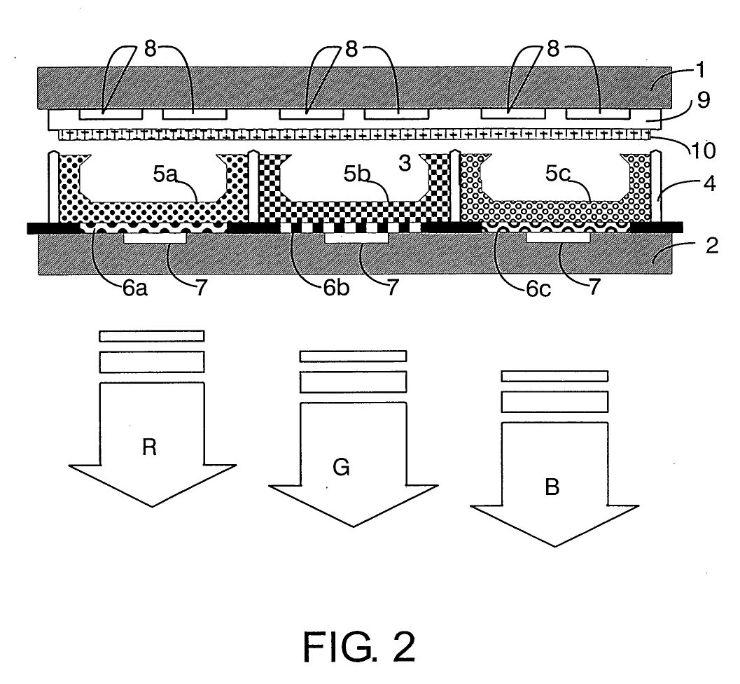

FIG. 2 is a diagrammatic, cross-sectional view of the structure of a further example of a transmission plasma display screen of the surface-discharge type in accordance with the invention.

FIG. 1 shows a surface discharge-type transmission plasma display screen comprising phosphor layers and color filter layers on the front plate, which transmission plasma display screen is composed of a system of individual layers which are arranged above one another and partly next to each other.

In a plasma color display screen of the surface discharge type, light is generated in a plasma by a gas discharge in a three-electrode system. Said three-electrode system comprises an address electrode and two discharge electrodes per pixel, between which an alternating voltage is applied during operation.

Said plasma color display screen is composed of a transparent front plate and a carrier plate, which are arranged at a distance from each other and are hermetically sealed at the periphery. The space between the two plates constitutes the discharge space 3.

The carrier plate comprises a carrier substrate 1, discharge electrodes 8 on the inner surface of the carrier substrate and a dielectric layer 9 which covers the discharge electrodes. The discharge electrodes are preferably made of a metal that reflects visible light. The dielectric layer is customarily made from a light-scattering translucent material. If the dielectric layer is translucent or transparent said dielectric layer is preferably used in combination with a visible light-reflecting layer between the carrier substrate and electrodes or between electrodes and the dielectric layer. The dielectric layer may alternatively be made from a visible light-reflecting material.

The dielectric layer is customarily also covered with a protective layer of magnesium oxide which reduces the ignition voltage for the gas discharge and precludes the dielectric layer from being sputtered off during the gas discharge.

The protective layer may additionally be provided with further layers which convert the UV-component of the radiation from the gas plasma into visible light and reflect said visible light.

The discharge electrodes extend orthogonally with respect to the plane of the drawing. To show all electrodes, the front plate shown in FIG. 1 is rotated through 90°. In the embodiment shown, the discharge electrodes are arranged in pairs on either side of a discharge channel, at a comparatively large distance from the next pair of discharge electrodes. Preferably, the discharge electrodes are made from a conductive material which, like for instance aluminum and silver, is highly reflective in the visible spectral range with a wavelength between 400 and 700 nm.

The front plate comprises a transparent front substrate 2, address electrodes and phosphor layers 5a, 5b, 5c. The address electrodes extend perpendicularly to the plane of the drawing and transversely to the direction of the discharge electrodes, so that a discharge can be ignited at each point of intersection.

Each address electrode is preferably embodied so as to be a composite electrode of a transparent strip electrode and a metallic bus electrode. The bus electrode is narrower than the transparent strip electrode and partly covers said strip electrode. As a result, light absorption and light reflection at the bus electrode are precluded.

Individually controllable discharge cells are formed by a ribbed structure of separating ribs 4. A ribbed structure comprising straight, parallel separating ribs divides the discharge space into uninterrupted vertical strips; a ribbed structure with buckled or corrugated separating ribs divides the discharge space into discontinuous chain-type vertically lined up discharge cells of, for example, hexagonal or ellipsoidal cross-section.

Between the separating ribs, the front plate is coated with a phosphor layer of phosphor segments. A picture element, i.e. a pixel, is defined by the combination of at least three sub-pixels in the colors red, green and blue. The sub-pixels are formed by the three luminescent segments 5a, 5b, 5c in the colors red, green and blue. Three discharge cells each comprising a red, green and blue segment each form a sub-pixel and, as a triad, a picture element.

The pattern of the phosphor segments is determined by the course of the separating ribs and vice versa. In the embodiment shown in FIG. 1, the segments of the phosphor layer form an in-line strip pattern, in which the segments form uninterrupted elongated strips. Along a strip, the color of the phosphor remains unchanged.

In accordance with another embodiment of the invention, the individual phosphor strips may be divided into rectangular phosphor segments (Mondrian pixels) for the three primary colors which are arranged in accordance with a zigzag pattern or a dovetail pattern.

The segments of the phosphor layer for the primary colors red, green and blue each comprise a red, green or blue-emitting phosphor. Particularly suitable phosphors are phosphors that can be excited by the UV component of the radiation from the gas plasma.

For the red-emitting phosphors that can be excited by UV radiation use can very suitably be made of manganese(II)-activated magnesium germanate, manganese(II)-activated magnesium fluorogermanate, rhodium-activated aluminum oxide, chromium-activated aluminum. oxide, copper-activated zinc cadmium sulphide, silver-activated zinc cadmium sulphide, manganese(II)-activated cadmium borate, manganese(II)-activated magnesium titanate, tin(II)-activated calcium orthophosphate, europium-activated yttrium vanadate, copper-activated zinc selenide and copper-activated zinc cadmium selenide.

For the blue-emitting phosphors that can be excited by UV-radiation use can very suitably be made of yttrium-activated strontium phosphate, silver-activated zinc sulphide, lead-activated calcium oxide, europium-activated barium magnesium aluminate, lead-activated tungsten oxide and uranium-activated cadmium tungstate.

For the green-emitting phosphors that can be excited by UV-radiation use can very suitably be made of manganese(II)-activated magnesium gallate, manganese(II)-activated zinc silicate, silver-activated zinc cadmium sulphide and terbium-activated zinc cadmium borate.

Also between the separating ribs and between the inner surface of the front substrate and the phosphor layer, the front plate is coated with a segmented filter layer. Each segment of the filter layer is assigned one segment of the phosphor layer.

The filter layer comprises wavelength-selective filter materials for the three primary colors. These filter materials have a spectral transmittance that allows wavelengths of the primary colors in question to pass and suppresses primary color wavelengths on one or both flanks of the spectrum (?). The absorption properties of the filter material must be adapted to the emission properties of the phosphor.

For the color filters use can particularly suitably be made of inorganic color pigments capable of withstanding maximum process temperatures during the manufacture of the front plate of 450 to 500° C. Typical pigments are Fe₂O₃, CdS—CdSe and TaOn as the red pigment, CoO—Al₂O₃—TiO₂—Cr₂O₃, TiO₂—CoO—NiO—ZrO₂ and TiO₂—ZnO—CoO—NiO as the green pigment, and CoO—Al₂O₃ and ultramarine as the blue pigment.

Advantageously, a segment of the phosphor layer containing red-emitting, europium-activated yttrium vanadate is combined with a segment of the color filter layer containing Fe₂O₃. It is also advantageous to combine a segment of the phosphor layer containing blue-emitting, europium-activated barium magnesium aluminate with a segment of the color filter layer containing cobalt aluminate CoO—Al₂O₃. If manganese-activated zinc silicate is used for the green-emitting segment of the phosphor layer, then a green color filter can be dispensed with.

The color pigments can additionally be mixed or coated with a lead glass frit having a low melting point, which is melted in the filter layer in the course of the manufacturing process so as to form a colored glass matrix.

The color filter layer may be provided before or after the manufacture of the separating ribs, and directly before the provision of the phosphor layer. This can also be carried out by means of photolithography or printing, such as ink-jet printing or screen printing.

In order to further increase the contrast, in this embodiment, black segments forming a black matrix are provided between the phosphor segments. For this purpose, a black pattern may be printed between the phosphor segments. The printing paste contains black metal oxides selected from the group formed by oxides of chromium, iron, cobalt, manganese and copper. The black matrix may extend below the separating ribs, as shown in FIG. 1, but it may alternatively also cover the side walls of the separating ribs.

In accordance with a further embodiment of the invention, the separating ribs may be made from a black material.

As shown in FIG. 2, the phosphor layer may be structured such that its thickness at the walls of the separating ribs is greater than its thickness on the color filter layer, and the thickness further increases in the direction of the carrier plate. In particular, the thickness of the phosphor layer at the walls of the separating ribs should be greater than the thickness on the color filter layer.

This thickness distribution is preferred as the efficiency of a plasma color display screen comprising a phosphor layer is decisively determined by the degree to which the generated UV light is absorbed in the phosphor as well as by the degree to which, subsequently, the generated visible light leaves the plasma color display screen in the direction of the viewer.

The absorption of the generated UV light is improved by providing the side walls of the separating ribs with phosphor layers of maximum thickness. The transmission of the generated colored light is improved, and a larger portion thereof reaches the viewer, by applying a comparatively thin phosphor layer over the filter layer and over the transparent front plate.

In FIG. 2, the address electrode is arranged between the front plate and the filter layer. As a result, the address electrode is shielded from the action of UV radiation.

The discharge space is filled with an appropriate discharge gas, for example xenon, a xenon-containing gas, neon or a neon-containing gas. The gas discharge is maintained between the discharge electrodes 8 on the carrier plate. In the discharge zone, the gas is ionized and a plasma emitting UV radiation develops. Dependent upon the composition of the gas in the discharge cell, the spectral intensity of the gas discharge is subject to change. Gas mixtures containing below 30% by volume of xenon emit predominantly resonance radiation at approximately 147 nm, gas mixtures containing more than 30% by volume of xenon emit predominantly excimer radiation at approximately 172 nm.

The emitted VUV radiation excites the structured red, green and blue phosphors pixel by pixel so as to emit light in the visible region, as a result of which a picture impression is formed. Ambient light, which is reflected by the phosphor layers in the absence of a filter layer, is weakened by the filter layers upon entering as well as upon leaving the display screen front. As a result, the contrast of the color display screen comprising color filters is improved substantially.

1. A plasma color display screen comprising a carrier plate, a transparent front plate, separating ribs which divide the space between the carrier plate and the front plate into discharge cells that are filled with a gas, one or more electrode arrays on the front plate and on the carrier plate to generate corona discharges in the discharge cells, a structured phosphor layer on the front plate composed of segments with red, green and blue-emitting phosphors and a structured filter layer composed of segments with color filters selected from the group of red, green and blue color filters, which filter layer is arranged between the inner surface of the front plate and the structured phosphor layer.

2. A plasma color display screen as claimed in claim 1, characterized in that the electrode array is arranged on the front plate between the filter layer and the front plate.

3. A plasma color display screen as claimed in claim 1, characterized in that the electrode array is arranged on the front plate between the filter layer and the phosphor layer.

4. A plasma color display screen as claimed in claim 1, characterized in that the segments of the color filter layer are separated from each other by black segments.

5. A plasma color display screen as claimed in claim 1, characterized in that the separating ribs are arranged on the filter layer.

6. A plasma color display screen as claimed in claim 1, characterized in that the walls of the separating ribs are additionally coated with a phosphor layer, the thickness of which is larger than the layer thickness of the phosphor layer on the front plate.

7. A plasma color display screen as claimed in claim 1, characterized in that the thickness of the phosphor layer on the separating ribs increases in the direction of the carrier plate.

8. A plasma color display screen as claimed in claim 1, characterized in that the electrode array on the carrier plate is covered, on the surface facing away from the carrier substrate, with a layer of a dielectric, visible light-reflecting material.

9. A plasma color display screen as claimed in claim 1, characterized in that the electrode array on the carrier plate is coated, on the surface facing away from the carrier substrate or on the surface facing the carrier substrate, with a layer of a visible light-reflecting material.
